(19) United States
(12) Patent Application Publication
(10) Pub. No.: US 2014/0281719 A1
(43) Pub. Date: Sep. 18, 2014

(54) EXPLAINING EXCLUDING A TEST FROM A TEST SUITE

(71) Applicant: INTERNATIONAL BUSINESS MACHINES CORPORATION, Armonk, NY (US)

(72) Inventor: Aviad Zlotnick, Mitzpeh Netofah (IL)

(73) Assignee: International Business Machines Corporation, Armonk, NY (US)

(21) Appl. No.: 13/798,119

(22) Filed: Mar. 13, 2013

(51) Int. Cl. G06F 11/263

(52) U.S. Cl. CPC G06F 11/263
USPC 714/32

(57) ABSTRACT

A method, apparatus and product for explaining excluding a test from a test suite. In one embodiment, the method comprising: obtaining a reduced test suite covering test requirements, the reduced test suite excluding a test covering a subset of the test requirements; determining, by a processor, a subset of the reduced test suite covering the subset of the test requirements; and outputting an indication that the subset of the test requirements is covered by the subset of the reduced test suite.

### TECHNICAL FIELD

The present disclosure relates testing in general, and to test selection, in particular.

### BACKGROUND

Almost every type of system, such as mechanical systems, biological systems, and computerized systems, may go through a testing phase during its life cycle. A process of developing, changing or maintaining a system may be expected to include a testing phase.

During the testing phase, a plurality of tests may be defined in order to examine a diversity of aspects of the system's functionality. In some cases, a testing phase comprises executing tests in order to examine the functionality of the system. Additionally or alternatively, tests are executed in order to detect functionally failures of the system. In some exemplary embodiments, regression tests are performed to ensure that a change in the system did not introduce new faults or modified desired functionality. Regression tests may also be performed to determine whether a change in one part of a system affects other parts of the system. In some cases, tests may examine system's behavior under both normal and anticipated peak load conditions. In some exemplary embodiments, tests may be used for testing integration of the system with additional systems or components.

A test may define actions to perform or the data to provide to a system during an execution of the test. In some exemplary embodiments, testers, QA staff members, and the like may execute a test. Additionally or alternatively, automatic testing tools may execute a test.

Tests may be used to examine system's compliance with its specified requirements. An aspect of the system to be tested is referred to as a test requirement. Each test may cover one or more test requirements when executed.

In some cases, tests may be grouped to a test suite, in order to cover all test requirements, to provide for benchmarks for similar systems, or for other reasons. The test suite may be a-priori planned, or may be created ad-hoc by grouping different tests that are devised for the system. The test requirements covered by the tests included in a test suite may be generally referred as the test suite coverage.

In some cases, in order to make the test process more efficient, test selection techniques may be used to determine a subset of a test suite that covers the same requirements covered by the test suite. In some exemplary embodiments, there may be a plurality of alternative reduced test suites. The test selection tool may determine any of the alternative reduced test suites, depending on, for example, the algorithm it applies, order of processing of tests, or the like.

Reducing the amount of executed tests by executing only the subset of the test suite may increase efficiency of the testing process.

### BRIEF SUMMARY

One exemplary embodiment of the disclosed subject matter is a computer-implemented method comprising: obtaining a reduced test suite covering test requirements, the reduced test suite excluding a test covering a subset of the test requirements; determining, by a processor, a subset of the reduced test suite covering the subset of the test requirements; and outputting an indication that the subset of the test requirements is covered by the subset of the reduced test suite.

Another exemplary embodiment of the disclosed subject matter is a computerized apparatus having a processor, the processor being adapted to perform the steps of: obtaining a reduced test suite covering test requirements, the reduced test suite excluding a test covering a subset of the test requirements; determining a subset of the reduced test suite covering the subset of the test requirements; and outputting an indication that the subset of the test requirements is covered by the subset of the reduced test suite.

Yet another exemplary embodiment of the disclosed subject matter is a computer program product comprising: a non-transitory computer readable medium retaining program instructions, which instructions when read by a processor, cause the processor to perform a method comprising: obtaining a reduced test suite covering test requirements, the reduced test suite excluding a test covering a subset of the test requirements; determining a subset of the reduced test suite covering the subset of the test requirements; and outputting an indication that the subset of the test requirements is covered by the subset of the reduced test suite.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a block diagram of an apparatus, in accordance with some exemplary embodiments of the disclosed subject matter; and

FIGS. 3A-3D show illustration of tables in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to provide an explanation for excluding of a test from a test suite.

When test selection or test suit minimization is utilized, tests are excluded from a test suite. However, the tester would like to verify that the exclusion of the test indeed does not reduce the coverage of the test suite. Although automatic tools may be used for test selection, the user may still not trust that valuable asserts (i.e. tests) are not tossed away for no good reason.

In some cases, such as for example due to manual definition of a coverage model, the list of covered test requirements for each test may not be accurate. If an explanation as to why a test is considered as redundant is provided to the user, the user may be able to understand whether the test is indeed redundant, whether some tests were incorrectly associated with a test requirement, whether some test requirements are not provided in the coverage model, or the like.

When a doubt rises with respect to the necessity or exclusion of a specific test of a test suite, the tester may ask for a clear convincing indication that the test is redundant and that removing the test from the test suite will not reduce the test suite efficiency. In some exemplary embodiments the disclosed subject matter may provide such an indication.

It will be noted that in some exemplary embodiments the test suite may be determined in any manner and tests may be excluded therefrom using tools such as test selection tools, but also in a manual manner. In some exemplary embodiments, the excluded test may not be a part of the test suite but rather it may be a potential addition to the test suite that is determined to be redundant and therefore not added to the test suite.

One technical solution is to automatically provide an indication that the test requirements covered by an excluded test are covered by other tests of the test suite. In some exemplary embodiments, the indication may be a list of tests of the test suite covering the test requirements covered by the excluded test.

In some exemplary embodiments, a test selection tool may be utilized in order to determine a reduced test suite. In order to provide an indication that a test excluded from the reduced test suite is redundant, test selection may be applied to the reduced test suite. The test selection may be applied in order to determine a subset of the reduced test suite, covering the test requirements that are covered by the test which was excluded from the reduced test suite. The list of tests of the subset, and the test requirements covered by these tests may be an indication that the excluded test is redundant by explaining the test requirements covered by the excluded test are covered by other tests of the test suite. In some exemplary embodiments, the first selection tool being used for the disclosed subject matter may be the same test selection tool used for reducing the test suite, or a different tool.

One technical effect of utilizing the disclosed subject matter is to enable a test suite designer to have more confident in the outcome of an automated test selection process. Another technical effect is enabling the test suite designer to review the excluded tests and identify problems in the coverage model, such as referring to two different test requirements as the same requirement. Yet another technical effect is to allow users to trust the automated outcomes and therefore use it to reduce the size of the test suite so as to increase efficiency of the testing process.

Referring now to FIG. 1 showing a flowchart diagram of a method, in accordance with some exemplary embodiments of the disclosed subject matter.

In Step 110, a test suite is obtained. A test suite is a group of tests that may be used to test a system by covering one or more of the test requirements of the system.

In Step 120, a set of test requirements covered by the test suite is determined. In some exemplary embodiments, the set of test requirements covered by the test suite may be determined by utilizing a coverage tool. In some cases, the set of test requirements covered by the test suite may be determined manually by analyzing the test suite. Additionally or alternatively, a set of test requirements covered by the test suite may be provided by the test suite designer.

In Step 130, a list of test requirements covered by each test of the test suite is obtained. In some exemplary embodiments, the list may be determined automatically by a coverage tool. In some exemplary embodiments, the list may be determined by manual analyses of the tests. Additionally or alternatively, the test suite designer may provide the list.

In Step 140, a reduced test suite with respect to the test suite is determined. Redundant tests, i.e. any test that may be excluded from the test suite without reducing the test suite coverage, may be excluded from the test suite, while the reduced test suite still covers the test requirements covered by the test suite. In some exemplary embodiments, the test suite may be reduced by applying a test selection algorithm to the test suite. In some cases, the test selection may be performed by a test selection tool.

In Step 150, a test not included in the reduced test suite is selected. In some exemplary embodiments, the selected test may be a test excluded from the test suite in Step 140. Additionally or alternatively, the selected test may be a test considered for being added to the reduced test suite, and determined that its addition would not increase coverage of the reduced test suite.

In Step 160, a subset of the reduced test suite is determined. The subset of the reduced test suite covers the test requirements covered by the selected test. The subset of the reduced test suite may be determined by applying test selection to the reduced test suite, with respect to the test requirements covered by the selected test. In some exemplary embodiments, a test selection tool may be utilized in order to automatically determine the subset. Additionally or alternatively, test selection may be implemented manually.

The outcome of Step 160 may be a set of tests that together cover every test requirement covered by the excluded test, and therefore explain why the excluded test is redundant. The set of tests may be minimal in the sense that excluding any test therefrom would render the excluded test as not redundant.

In Step 170, a report is provided to a user, comprising one or more reasons for not including the selected test in the reduced test suite. In some exemplary embodiments, the report may provide a list of tests included in the reduced test suite covering the test requirements covered by the selected test (i.e. the subset of Step 160). In some cases, the list of test may be accompanied by a list of the test requirements covered by each test of the list. Additionally or alternatively, the list of test requirements may point only test requirements covered by the selected test. Additionally or alternatively, the report may refer to the list of test requirements covered by the selected test, and provide, with respect to each test requirement, a list of tests of the reduced test suite, covering that specific test requirement. The list of such tests may be selected from the subset of the reduced test suite.

In some exemplary embodiments, the selected test may be a group of tests excluded from the test suite. In some exemplary embodiments, the selected test may be a group of tests that are considered for being added to the reduced test suite.

In some exemplary embodiments, when more than one test is selected to provide an explanation for not being included in the reduced test suite, Steps 150-170 may be performed with respect to each test of the selected tests, and the report provided in Step 170 may refer to the selected tests as a group or may refer to each selected test separately.

In some exemplary embodiments, when more than one test is selected, Steps 150-170 may be performed referring the selected tests as one test. In some exemplary embodiments, the selected tests may be referred to as one test by performing Step 160 or by performing Step 160 and Step 170 with respect to test requirements covered by all selected tests.

Referring now to FIG. 2 showing an apparatus in accordance with some exemplary embodiments of the disclosed subject matter. Apparatus 200 of FIG. 2, may be configured to provide a reason for not including a test in a test suite, in accordance with the disclosed subject matter.

In some exemplary embodiments, Apparatus 200 may comprise a Processor 202. Processor 202 may be a Central Processing Unit (CPU), a microprocessor, an electronic circuit, an Integrated Circuit (IC) or the like. Processor 202 may be utilized to perform computations required by Apparatus 200 or any of it subcomponents.

In some exemplary embodiments of the disclosed subject matter, Apparatus 200 may comprise an Input/Output (I/O) Module 205. I/O module 205 may be utilized to provide an output to and receive input from a user, such as User 280. In some exemplary embodiments, I/O Module 205 may be utilized to provide an interface to a user, which may utilize a Man-Machine Interface (MMI) such as but not limited to Computer Terminal 285, to interact with Apparatus 200, such as by reviewing results, logs and the like, providing tests, data, lists, commands, rules, preferences, formulas or the like, or interacting in any similar manner.

In some exemplary embodiments, Apparatus 200 may comprise a Memory Unit 207. Memory Unit 207 may be a hard disk drive, a Flash disk, a Random Access Memory (RAM), a memory chip, or the like. In some exemplary embodiments, Memory Unit 207 may retain program code operative to cause Processor 202 to perform acts associated with any of the subcomponents of Apparatus 200. In some exemplary embodiments, Memory Unit 207 may retain Test Suite 210 or additional tests, Test Requirements 220 such as obtain in Step 130, determined in Step 120, or the like. In some exemplary embodiments, Test Requirements 220 may indicate for each test of Test Suite 210 a list of test requirements covered thereby.

The components detailed below may be implemented as one or more sets of interrelated computer instructions, executed for example by Processor 202 or by another processor. The components may be arranged as one or more executable files, dynamic libraries, static libraries, methods, functions, services, or the like, programmed in any programming language and under any computing environment.

A Redundant Test Explanation Module 230 may be configured to provide an explanation for not including a test, such as the test selected in Step 150 of FIG. 1, in a test suite, such as the reduced test suite determined in Step 140 of FIG. 1.

A Test Selection Module 240 may be configured to perform test selection. The test selection may minimize a test suite by excluding redundant tests. Therefrom, test selection may be implemented, for example, as described in Yoo, S. and Harman, M. Regression Testing Minimization, Selection and Prioritization: A Survey, Software: Testing, Verification and Reliability, Vol. 22(2), pg. 67-120 (2012), which is hereby incorporated by reference in its entirety for all purposes. Test Selection Module 240 may be configured to perform Step 140 of FIG. 1. Test Selection Module 240 may be utilized by Redundant Test Explanation Module 230 such as for performing test selection useful for providing the explanation, such as depicted in Step 160 of FIG. 1.

A Coverage Module 250 may be configured to determine the test requirements covered by a test or by a test suite. Coverage Module 250 may be utilized when Step 120 of FIG. 1 or Step 130 of FIG. 1 are performed. In some exemplary embodiments, the Coverage Module 250 may be utilized when Step 160 of FIG. 1 is performed to determine the test requirements covered by the selected test.

A Report Generator 260 may be configured to provide User 280 a report comprising a reason for not including the test selected in Step 150 of FIG. 1 in the reduced test suite determined in Step 140 of FIG. 1. In some exemplary embodiments, Report Generator 260 may perform Step 170 of FIG. 1.

Referring now to FIGS. 3A-3D showing illustration of tables in accordance with some exemplary embodiments of the disclosed subject matter.

Test Suite Table 300 of FIG. 3A presents a test suite comprising six tests. The rows of Test Suite Table 300 refer to tests of the test suite, such as Test 302 and Test 304. Each test may be identified, such as using a unique identifier (e.g., a number), a name, or the like. Each column of Test Suite Table 300 is associated with a different test requirement, such as Test Requirement 314, and Test Requirement 316. Each requirement may be identified using a unique identifier (e.g., a letter), a name, or the like. A test requirement covered by a test is marked with a plus sign such as Plus Sign 318.

Table 320 of FIG. 3B shows the reduced test suite, which may be an outcome of applying test selection on the test suite of Test Suite Table 300. As can be appreciated, Test 304 and Test 310 were excluded from the test suite as being redundant, while Tests 302, 306, 308, 312 are included in the reduced test suite.

As further can be appreciated, alternative reduced test suites are also a valid possible outcome of a test selection process on the test suite.

Table 330 of FIG. 3C shows a subset of the reduced test suite, with respect to Test 304. The subset may be determined by test selection applied to the reduced test suite with respect to Test Requirement 314 and Test Requirement 316 covered by Test 304. In some exemplary embodiments, Table 330 shows the subset which can be used to explain why Test 304 was excluded from the test suite as not adding to the coverage of the reduced test suite.

Tables 340 and 350 of FIG. 3D provide an explanation for excluding Test 304 from the reduced test suite. Table 340 and Table 350 explain that Test 304 is redundant by demonstrating how Test Requirement 314 and Test Requirement 316 which are the covered by Test 304, are covered by Test 302 and Test 308 of the reduced test suite. Table 340 displays Test Requirement 314, which is covered by Test 304, being covered by Test 302 of the reduced test suite, and Table 350 displays Test Requirement 316 covered by Test 304, being covered by Test 308 of the reduced test suite. Additionally or alternatively, additional tests of the reduced test suite which cover Test Requirement 314 or 316 may be indicated in Table 340 or Table 350, respectively.

In some exemplary embodiments, the disclosed subject matter may be applied with respect to a suite of test data. A suite of test data may be a collection of data units each of which may be used in a test for testing a system. In some exemplary embodiments, when a suite of test data is used, a test or a test suite may be performed more than once, each time with respect to a different data unit of the suite of test data. In some exemplary embodiments, different data units may be configured to cause the test to cover a different set of test requirements. As an example only, the data units may be an input provided to the system while the test is being executed. One data unit may cause the test to invoke a first model and therefore be useful in checking test requirements associated with the first model while another data unit may cause the test to invoke a second model and therefore be useful in checking different test requirements that are associated with the second model.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining a reduced test suite covering test requirements, the reduced test suite excluding a test covering a subset of the test requirements;
determining, by a processor, a subset of the reduced test suite covering the subset of the test requirements; and
outputting an indication that the subset of the test requirements is covered by the subset of the reduced test suite.

2. The computer-implemented method of claim 1, wherein the reduced test suite is an outcome of applying test selection on a test suite comprising the reduced test suite and the excluded test.

3. The computer-implemented method of claim 1, wherein any test in the reduced test suite covers at least one test requirement of the subset of the test requirements that is not covered by any other test in the reduced test suite.

4. The computer-implemented method of claim 1, wherein said determining the subset of the reduced test suite comprises applying test selection on the reduced test suite with respect to the subset of the test requirements.

5. The computer-implemented method of claim 1, wherein the indication comprises:
a list of tests of the subset of the reduced test suite; and
a list of test requirements covered by each test of the list of tests of the subset of the reduced test suite.

6. The computer-implemented method of claim 1, wherein the indication comprises:
a list of test requirements of the subset of the test requirements; and
a list of tests of the subset of the reduced test suite covering each test requirement of the list of the test requirements of the subset of the test requirements.

7. The computer-implemented method of claim 1, wherein the indication is a list of tests of the subset of the reduced test suite.

8. The computer-implemented method of claim 1, wherein the test suite is a suite of test data to be used in a test, wherein different test data is configured to cause the test to cover a different test requirement.

9. The computer-implemented method of claim 1 further comprising: obtaining a list of test requirements covered by each test of the reduced test suite.

10. A computerized apparatus having a processor, the processor being adapted to perform the steps of:
obtaining a reduced test suite covering test requirements, the reduced test suite excluding a test covering a subset of the test requirements;
determining a subset of the reduced test suite covering the subset of the test requirements; and
outputting an indication that the subset of the test requirements is covered by the subset of the reduced test suite.

11. The computerized apparatus of claim 10, wherein the reduced test suite is an outcome of applying test selection on a test suite comprising the reduced test suite and the excluded test.

12. The computerized apparatus of claim 10, wherein any test in the reduced test suite covers at least one test requirement of the subset of the test requirements that is not covered by any other test in the reduced test suite.

13. The computerized apparatus of claim 10, wherein said determining the subset of the reduced test suite comprises applying test selection on the reduced test suite with respect to the subset of the test requirements.

14. The computerized apparatus of claim 10, wherein the indication comprises:
a list of tests of the subset of the reduced test suite; and
a list of test requirements covered by each test of the list of tests of the subset of the reduced test suite.

15. The computerized apparatus of claim 10, wherein the indication comprises:
a list of test requirements of the subset of the test requirements; and
a list of tests of the subset of the reduced test suite covering each test requirement of the list of the test requirements of the subset of the test requirements.

16. The computerized apparatus of claim 10, wherein the indication is a list of tests of the subset of the reduced test suite.

17. The computerized apparatus of claim 10, wherein the test suite is a suite of test data to be used in a test, wherein different test data is configured to cause the test to cover a different test requirement.

18. The computerized apparatus of claim 10, wherein said processor is further adapted to perform the step of obtaining a list of test requirements covered by each test of the reduced test suite.

19. A computer program product comprising:
a non-transitory computer readable medium retaining program instructions, which instructions when read by a processor, cause the processor to perform a method comprising:
obtaining a reduced test suite covering test requirements, the reduced test suite excluding a test covering a subset of the test requirements;
determining a subset of the reduced test suite covering the subset of the test requirements; and
outputting an indication that the subset of the test requirements is covered by the subset of the reduced test suite.
